(19) United States
(12) Patent Application Publication
(10) Pub. No.: US 2026/0133802 A1
(43) Pub. Date: May 14, 2026

(54) INFORMATION PROCESSING DEVICE, INFORMATION PROCESSING METHOD, AND RECORDING MEDIUM

(71) Applicants: NEC Corporation, Tokyo (JP); NATIONAL INSTITUTE OF ADVANCED INDUSTRIAL SCIENCE AND TECHNOLOGY, Tokyo (JP)

(72) Inventors: So YAMADA, Tsukuba-shi (JP); Atsumi SAITO, Tsukuba-shi (JP); Keisuke YAMAZAKI, Tsukuba-shi (JP); Takashi WASHIO, Tsukuba-shi (JP)

(73) Assignees: NEC Corporation, Tokyo (JP); NATIONAL INSTITUTE OF ADVANCED INDUSTRIAL SCIENCE AND TECHNOLOGY, Tokyo (JP)

(21) Appl. No.: 19/118,487

(22) PCT Filed: Aug. 29, 2023
(86) PCT No.: PCT/JP2023/031102

§ 371 Date: Apr. 4, 2025

(30) Foreign Application Priority Data
Oct. 12, 2022 (JP) 2022-164055

(51) Int. Cl. G06F 9/30

(52) U.S. Cl. CPC G06F 9/30181

(57) ABSTRACT

This information processing device obtains an acquisition function using kernel mean embedding of a conditional distribution estimated from a data set obtained by data sampling. The information processing device determines a sampling point, from which data is acquired, based on the acquisition function. The information processing device acquires the data at the determined sampling point.

### TECHNICAL FIELD

The present disclosure relates to an information processing device, an information processing method, and a recording medium.

### BACKGROUND ART

Bayesian optimization is known as a method for efficiently acquiring data. For example, Patent Document 1 describes a technique of performing a parameter search using a Bayesian optimization method, with the parameter being a voltage applied to a liquid chromatograph mass spectrometer. Furthermore, Patent Document 1 describes that in Bayesian optimization, under an assumption that the model of an experimental subject follows a Gaussian process, a mean value and a variance value of the posterior distribution of a model function are calculated based on acquired observation data, and the next experimental conditions are determined based on the calculated values.

### PRIOR ART DOCUMENTS

### Patent Documents

Patent Document 1: PCT International Publication No. WO2019/244474

### SUMMARY OF INVENTION

### Problems to be Solved by the Invention

In a case of determining the sampling point from which data is acquired, it is preferable that the probability distribution assumed for the value of the data to be acquired is not limited to a specific type of distribution.

An example object of the present disclosure is to provide an information processing device, an information processing method, and a recording medium that are capable of solving the above problem.

### Means for Solving the Problem

According to a first example aspect of the present disclosure, an information processing device includes: an acquisition function acquiring means that acquires an acquisition function using kernel mean embedding of a conditional distribution estimated from a data set obtained by data sampling; a sampling point determining means that determines a sampling point, from which data is acquired, based on the acquisition function; and a data acquiring means that acquires data at the sampling point determined by the sampling point determining means.

According to a second example aspect of the present disclosure, an information processing method is executed by a computer and includes: acquiring an acquisition function using kernel mean embedding of a conditional distribution estimated from a data set obtained by data sampling; determining a sampling point, from which data is acquired, based on the acquisition function; and acquiring data at the determined sampling point.

According to a third example aspect of the present disclosure, a recording medium stores a program that causes a computer to execute the steps of: acquiring an acquisition function using kernel mean embedding of a conditional distribution estimated from a data set obtained by data sampling; determining a sampling point, from which data is acquired, based on the acquisition function; and acquiring data at the determined sampling point.

### Effect of Invention

According to the present disclosure, in case of determining a sampling point from which data is acquired, the probability distribution assumed for the value of the data to be acquired is not limited to a specific type of distribution.

### BRIEF DESCRIPTION OF DRAWINGS

FIG. 1 is a diagram showing an example of a configuration of an information processing device according to several example embodiments of the present disclosure.

FIG. 2 is a diagram showing a plurality of examples of Gaussian kernel functions.

FIG. 3 is a diagram showing an example of superimposition of a plurality of Gaussian kernel functions.

FIG. 4 is a diagram showing an example of integration of a Gaussian kernel function.

FIG. 5 is a diagram showing an example of the relationship between an approximation function of a PI acquisition function and a bandwidth.

FIG. 6 is a diagram showing an example of the relationship between an approximation function of an EI acquisition function and a bandwidth.

FIG. 7 is a diagram showing an example of a processing procedure performed in case where an information processing device according to several example embodiments of the present disclosure performs a solution search.

FIG. 8 is a diagram showing another example of a configuration of an information processing device according to several example embodiments of the present disclosure.

FIG. 9 is a diagram showing an example of a configuration of a system according to several example embodiments of the present disclosure.

FIG. 10 is a diagram showing an example of a processing procedure of an information processing method according to several example embodiments of the present disclosure.

FIG. 11 is a schematic block diagram showing a configuration of a computer according to at least one example embodiment.

### EXAMPLE EMBODIMENT

Hereunder, example embodiments of the present disclosure will be described. However, the following example embodiments do not limit the invention according to the claims. Furthermore, not all combinations of features described in the example embodiments may not be essential to the solution means of the invention.

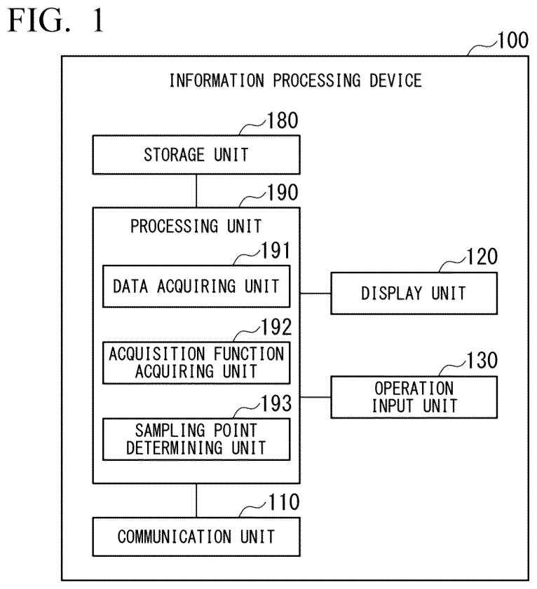

FIG. 1 is a diagram showing an example of a configuration of an information processing device according to several example embodiments of the present disclosure. In the configuration shown in FIG. 1, the information processing device 100 includes a communication unit 110, a display unit 120, an operation input unit 130, a storage unit 180, and a processing unit 190. The processing unit 190 includes a data acquiring unit 191, an acquisition function acquiring unit 192, and a sampling point determining unit 193.

The information processing device 100 acquires data. In particular, the information processing device 100 performs data sampling to determine one or more of a maximum value or a largest possible value of sampling target data, a condition that causes the sampling target data to take the maximum value or the largest possible value, a minimum value or a smallest possible value of the sampling target data, and a condition that causes the sampling target data to take the minimum value or the smallest possible value. In a case of performing the data sampling, the information processing device 100 determines the next sampling point based on data that has already been obtained.

The information processing device 100 may, for example, be configured by using a computer such as a personal computer (PC) or a workstation (WS).

The data sampling referred to here refers to determining conditions under which data are acquired, and acquiring data under the conditions that have been determined. The sampling target data represents the data subjected to acquisition. Acquiring the data is also referred to as observing the data. The conditions under which data are acquired are also referred to as a sampling point or an observation point.

Data in which a sampling point and sampling target data at the sampling point are associated with each other is also referred to as sample data. A set of sample data is referred to as a sample data set, or simply as a data set.

For example, in a case where the information processing device 100 determines a parameter value to be set to a device that produces a certain product such that the production speed is made as large (fast) as possible, the parameter value can serve as the sampling point, and the production speed can serve as the sampling target data. In this case, determining a parameter value for data acquisition, setting the parameter value that has been determined to the device, and then measuring the production speed of the product by the device when the parameter value is set corresponds to an example of data sampling.

Making a value such as the production speed as large as possible is also referred to as maximizing the value.

The information processing device 100 may also automatically set, to the device, the parameter value that has been acquired as the parameter value for making the production speed as large as possible. Alternatively, the information processing device 100 may also display, to the user, the parameter value that has been acquired as the parameter value for making the production speed as large as possible.

Alternatively, in a case where the information processing device 100 determines a parameter value to be set to a communication system in order to reduce an error rate (for example, a bit error rate) of the communication system as much as possible, the parameter value can serve as the sampling point, and the error rate can serve as the sampling target data. In this case, determining the parameter value for data acquisition, setting the parameter value that has been determined to the communication system, and then measuring the error rate in the communication system when the parameter value is set corresponds to an example of data sampling.

Making a value such as the error rate as small as possible is also referred to as minimizing the value.

The information processing device 100 may also automatically set, to the communication system, the parameter value that has been acquired as the parameter value for making the error rate as small as possible. Alternatively, the information processing device 100 may also display, to the user, the parameter value that has been acquired as the parameter value for making the error rate as small as possible.

Determining one or more of a maximum value or a largest possible value of sampling target data, a condition that causes the sampling target data to take the maximum value or the largest possible value, a minimum value or a smallest possible value of the sampling target data, and a condition that causes the sampling target data to take the minimum value or the smallest possible value is also referred to as a solution search, or a sampling point search.

Hereunder, an example will be described where the information processing device 100 determines (searches for) a sampling point such that the sampling target data is increased as much as possible.

However, the data searching performed by the information processing device 100 is not limited to this. As described above, the information processing device 100 may determine a value of the sampling target data that is as large as possible. Alternatively, the information processing device 100 may determine a sampling point such that the sampling target data is as small as possible. Alternatively, the information processing device 100 may determine a value of the sampling target data that is as small as possible.

In addition, the information processing device 100 may determine a plurality of the data mentioned above, and may determine the sampling target data that is as large as possible, and the sampling point at that time.

The information processing device 100 acquires an acquisition function using kernel mean embedding, and performs data sampling by determining a sampling point using the acquisition function that has been acquired. The solution search performed by the information processing device 100 can be considered as a Bayesian optimization using kernel mean embedding as a surrogate model. The surrogate model referred to here is a model that is configured based on sample data.

The communication unit 110 performs communication with other devices. For example, in a case where the information processing device 100 determines a parameter value to be set to a device subjected to data acquisition as the sampling point for acquiring sampling target data, the communication unit 110 may set the parameter value that has been determined by transmitting the parameter value to the device subjected to data acquisition. Also, the communication unit 110 may receive the sampling target data from the device subjected to data acquisition.

In addition, in a case where the information processing device 100 automatically sets the parameter value, which has been acquired as the parameter value for increasing the value of the sampling target data as much as possible, to the device subjected to data acquisition, the communication unit 110 may transmit and set the parameter value with respect to the device subjected to data acquisition.

The display unit 120 includes, for example, a display screen such as a liquid crystal panel or an LED (Light Emitting Diode) panel, and displays various images. For example, the display unit 120 may display the value that has been obtained as the value of the sampling target data that is as large as possible, and the sampling point at which the value is acquired, or may display either one of these values.

Furthermore, the display unit 120 may display a processing status when the information processing device 100 is performing a data search. For example, the display unit 120 may display a probability distribution of the sampling target data for each sampling point in the form of a graph or the like.

The operation input unit 130 includes input devices such as a keyboard and a mouse, and receives user operations. For example, the operation input unit 130 may receive a user operation that specifies a data search range, such as a domain of the sampling points, and a value range of the sampling target data. In addition, the operation input unit 130 may receive a user operation that specifies a sampling termination condition, such as the number of times sampling is to be repeated.

The storage unit 180 stores various types of data. The storage unit 180 is configured by using a storage device included in the information processing device 100.

The processing unit 190 performs various processing that controls each unit of the information processing device 100. The functions of the control unit 190 are executed, for example, as a result of a CPU (Central Processing Unit) included in the information processing device 100 reading and executing a program from the storage unit 180.

The data acquiring unit 191 acquires sample data. Specifically, the data acquiring unit 191 acquires the initial values of a data set. Furthermore, the data acquiring unit 191 acquires sampling target data of the sampling point that has been determined by the sampling point determining unit 193, and updates the data set. The data acquiring unit 191 corresponds to an example of a data acquiring means.

The data set that is acquired and updated by the data acquiring unit 191 is used to estimate a kernel mean embedding when the acquisition function acquiring unit 192 acquires an acquisition function. The kernel mean embedding acquired by the data acquiring unit 191 can be regarded as a surrogate model of a probability distribution of the sampling target data. As a result of the data acquiring unit 191 updating the data set, the acquisition function acquiring unit 192 is capable of increasing the estimation accuracy of the kernel mean embedding, and it is expected that an acquisition function having a higher accuracy can be obtained.

The initial values of the data set are used by the acquisition function acquiring unit 192 to make an initial estimate of the kernel mean embedding. The number of sample data included in the initial values of the data set may be one or more, and is not limited to a specific number.

In acquiring the initial values of the data set, the data acquiring unit 191 or the sampling point determining unit 193 may select one or more sampling points from the domain of the sampling points. Further, the data acquiring unit 191 may acquire sampling target data for each selected sampling point. The selection method of the sampling points in this case is not limited to a specific method. For example, the data acquiring unit 191 or the sampling point determining unit 193 may select sampling points that evenly divide the domain of the sampling points. Alternatively, the data acquiring unit 191 may randomly select the sampling points. Alternatively, the sampling points that are employed as the initial values of the data set may be specified in advance.

Alternatively, the storage unit 180 may store the initial values of the data set in advance. Then, the data acquiring unit 191 may read the initial values of the data set from the storage unit 180.

In updating the data set, the data acquiring unit 191 generates sample data in which the sampling point determined by the sampling point determining unit 193 and the sampling target data obtained at the sampling point are associated with each other. Then, the data acquiring unit 191 updates the data set by adding the generated sample data to the data set.

In sampling the data, the information processing device 100 may automatically perform the sampling of the data. For example, in a case where the data acquiring unit 191 or the sampling point determining unit 193 determines, as the sampling point, the parameter value to be set to the device subjected to data acquisition, the data acquiring unit 191 may transmit and set the parameter value that has been determined to the device subjected to data acquisition via the communication unit 110. Further, the data acquiring unit 191 may receive the sampling target data from the device subjected to data acquisition via the communication unit 110.

Alternatively, the information processing device 100 may display the sampling point to the user, and the user may set the sampling point. For example, the sampling point that has been determined by the data acquiring unit 191 or the sampling point determining unit 193 may be displayed to the user by being displayed on the display unit 120.

In the acquisition of the sampling target data, the data acquiring unit 191 may acquire the sampling target data from the device subjected to data acquisition, or from a sensor that measures the sampling target data via the communication unit 110. Alternatively, the user may input the sampling target data using the operation input unit 130, and the data acquiring unit 191 may acquire the sampling target data that has been input.

The acquisition function acquiring unit 192 acquires an acquisition function. More specifically, the acquisition function acquiring unit 192 estimates the kernel mean embedding based on the data set, and calculates an acquisition function using the estimated kernel mean embedding. The acquisition function acquiring unit 192 corresponds to an example of an acquisition function acquiring means.

The sampling point determining unit 193 determines the sampling point at which the data acquiring unit 191 performs data sampling. The sampling point determining unit 193 determines the sampling point based on the acquisition function that has been acquired by the acquisition function acquiring unit 192. The sampling point determining unit 193 corresponds to an example of a sampling point determining means.

For example, the sampling point determining unit 193 may select the sampling point at which the value of the acquisition function becomes as large as possible, such as the sampling point at which the acquisition function takes a maximum value, as the sampling point at which the data acquiring unit 191 performs data sampling. Alternatively, depending on the acquisition function, the sampling point determining unit 193 may select the sampling point at which the value of the acquisition function becomes as small as possible, such as the sampling point at which the acquisition function takes a minimum value, as the sampling point at which the data acquiring unit 191 performs data sampling.

The sampling point determining unit 193, the acquisition function acquiring unit 192, and the data acquiring unit 191 repeat the determination of the sampling point, the acquisition of the acquisition function, and the acquisition of data until a termination condition of the solution search by the information processing device 100 is met.

The acquisition function that is acquired by the acquisition function acquiring unit 192 will be further described.

Let a certain probability space be represented by (Y*, F, P). Y* represents a sample set (sample space). F represents the a-algebra of the sample set Y*. P represents a probability measure.

If a random variable having values that are elements of a sample set Y* is denoted by Y, then a kernel mean embedding (KME) μ_{Y} is expressed as in expression (1).

$$[ Expression 1 ]$$

$${μ}_{Y} := {E}_{Y} [ {k}_{{Y}^{*}} ( \cdot , Y ) ] = {\int }_{{Y}^{*}} {k}_{{Y}^{*}} ( \cdot , y ) dP ( y ) ∈ H \qquad ( 1 )$$

Here, “:=” indicates that the right side is the definition of the left side. In the case of expression (1), the kernel mean embedding μ_{Y} is defined as E_{Y}[k_{Y*}(⋅, Y)].

E represents the expected value. E_{Y} represents the expected value of the random variable Y.

k_{Y*}(⋅, Y) is a measurable positive definite kernel function on the sample set Y*. The “⋅” in k_{Y*}(⋅, Y) is a wild card, that is to say, indicates that the argument is undetermined.

y represents the value of the random variable Y. Therefore, as shown in expression (2), y represents an element of the sample set Y*.

$$[ Expression 2 ]$$

$$y ∈ {Y}^{*} \qquad ( 2 )$$

H in expression (1) represents a reproducing kernel Hilbert space (RKHS).

If the kernel function k_{Y*}(⋅, Y) is characteristic, the kernel mean embedding μ_{Y}:P*→H is injective. Here, let P* be the set of values that the probability measure P can take on the sample set Y*.

If the kernel mean embedding μ_{Y}:P*→H is injective, the kernel mean embedding μ_{Y} is a sufficient class to represent the moments of all dimensions of a probability distribution. For this reason, the kernel mean embedding μ_{Y} can be said to preserve the information of the probability distribution.

Assuming a distribution conditioned on a certain realization value x of a random variable X whose values are the elements of a certain sample set X*, the kernel mean embedding μ_{Y}|x of the conditional distribution can be expressed as expression (3) based on expression (1).

$$[ Expression 3 ]$$

$${μ}_{Y \vert x} := {E}_{Y \vert x} [ {k}_{{Y}^{*}} ( \cdot , Y ) ] = {\int }_{{Y}^{*}} {k}_{{Y}^{*}} ( \cdot , y ) dP ( y \vert x ) ∈ H \qquad ( 3 )$$

Given a data set {(xᵢ, yᵢ)}ᵢ₌₁ⁿ, the estimate μ\hat{ }_{Y|x} of the kernel mean embedding of an empirical conditional distribution is expressed as in expression (4).

$$[ Expression 4 ]$$

$${\hat{μ}}_{Y \vert x} = {\sum }_{i = 1}^{n} {w}_{i} ( x ) {k}_{{Y}^{*}} ( \cdot , {y}_{i} ) \qquad ( 4 )$$

A character with a circumflex (\hat{ }) may be expressed by adding “\hat{ }” after the character, such as in “μ\hat{ }”.

Expression (4) can be used as an approximation of expression (3).

The weights wᵢ(x) are expressed as in expression (5).

$$[ Expression 5 ]$$

$$\begin{matrix}w ( x ) := {( {w}_{i} ( x ) , … , {w}_{n} ( x ) )}^{T} \\ := {( G + n ε {I}_{n} )}^{- 1} {k}_{{X}^{*}} ( x )\end{matrix} \qquad ( 5 )$$

The superscript T denotes the transpose of a vector or matrix.

ε is a constant for performing normalization, where ε>0.

Iₙ represents an identity matrix with n rows and n columns.

k_{X*}(x) is a measurable positive definite kernel function on the sample set X*, and is expressed as in expression (6).

$$[ Expression 6 ]$$

$${k}_{{X}^{*}} ( x ) := {( {k}_{{X}^{*}} ( {x}_{1} , x ) , … , {k}_{{x}^{*}} ( {x}_{n} , x ) )}^{T} ∈ {R}^{n} \qquad ( 6 )$$

Rⁿ represents the n-dimensional real space.

G in expression (5) is a matrix with n rows and n columns, and an element Gᵢⱼ of the matrix G is expressed as in expression (7).

$$[ Expression 7 ]$$

$${G}_{ij} := {k}_{{X}^{*}} ( {x}_{i} , {x}_{j} ) \qquad ( 7 )$$

Furthermore, if g(Y) is a function in the reproducing kernel Hilbert space H, the conditional expected value E_{Y|x}[g(Y)] of g(Y) is expressed as in expression (8).

$$[ Expression 8 ]$$

$${E}_{Y \vert x} [ g ( Y ) ] = {〈 g , {μ}_{Y \vert x} 〉}_{H} \qquad ( 8 )$$

<⋅, ⋅>_{H} denotes an inner product on the reproducing kernel Hilbert space H.

As an example of an acquisition function that is acquired by the acquisition function acquiring unit 192, a case will be described in which a PI (probability of improvement) acquisition function or an EI (expected improvement) acquisition function is configured using kernel mean embedding.

### (PI Acquisition Function)

A PI acquisition function α_{PI} is defined as the probability that a random variable Y takes a value equal to or greater than a certain value y⁺, and is expressed as shown in expression (9).

$$[ Expression 9 ]$$

$$\begin{matrix}{α}_{PI} ( x ) := {\int }_{{y}^{+}}^{+ ∞} dP ( y \vert x ) \\ = {E}_{Y \vert x} [ u ( Y ) ]\end{matrix} \qquad ( 9 )$$

If the largest value of yᵢ of a given data set {(xᵢ, yᵢ)}ᵢ₌₁ⁿ is used as y⁺, according to a PI, it is possible to select, as the next sampling point, the value of x having the highest probability of updating the maximum value of the value y of the random variable Y.

u is a unit step function (or a Heaviside step function) expressed by expression (10).

$$[ Expression 10 ]$$

$$u ( y ) := \{ \begin{matrix}1 ( y > {y}^{+} ) \\ \frac{1}{2} ( y = {y}^{+} ) \\ 0 ( y < {y}^{+} )\end{matrix} \qquad ( 10 )$$

As shown in expression (9), the PI acquisition function α_{PI} is expressed as the expected value of the unit step function u(Y) in the conditional distribution P(Y|x).

In an acquisition function, the function from which an expected value is taken is also referred to as an integrand function. In the case of a PI, the unit step function u is also referred to as the integrand function g_{PI} of the PI. The integrand function g_{PI} is expressed as in expression (11).

$$[ Expression 11 ]$$

$${g}_{PI} ( y ) = u ( y ) \qquad ( 11 )$$

In a case where the integrand function g belongs to the reproducing kernel Hilbert space H, the expected value E_{Y|x}[g(Y)] can be calculated by the inner product of the integrand function g and the estimated kernel mean embedding μ\hat{ }_{Y|x}, as shown in expressions (8) and (4). Therefore, approximation of the integrand function g by a linear combination of kernel functions k_{y} used in the kernel mean embedding such that the integrand function g belongs to the reproducing kernel Hilbert space H will be considered.

Here, an example will be described in which a Gaussian kernel function is used to express the unit step function u, which is the integrand function g_{PI} in a PI.

However, the kernel function used in the acquisition function that is acquired by the acquisition function acquiring unit 192 is not limited to the Gaussian kernel function, and various kernel functions capable of expressing or approximating the integrand function can be used. For example, in a case where the acquisition function acquiring unit 192 acquires the PI acquisition function α_{PI} as the acquisition function, various kernel functions capable of expressing or approximating the unit step function u can be used as part of the PI acquisition function α_{PI}.

It is assumed that the kernel function used to express or approximate the integrand function, and the kernel function k_{Y*}(⋅, Y) used in the kernel mean embedding are the same kernel function.

A Gaussian kernel function is also referred to as a radial basis function, or a squared exponential. The Gaussian kernel function k_{y}(yᵢ, yⱼ) is expressed as in expression (12).

$$[ Expression 12 ]$$

$${k}_{y} ( {y}_{i} , {y}_{j} ) = C exp ( - \frac{{( {y}_{i} - {y}_{j} )}^{2}}{h} ) \qquad ( 12 )$$

exp represents an exponential function.

h is a constant representing the bandwidth, where h>0.

C is a constant, and C as shown in expression (13) is used here.

$$[ Expression 13 ]$$

$$C = \frac{1}{\sqrt{π h}} \qquad ( 13 )$$

In a case where C represented by expression (13) is used, the Gaussian kernel function k_{y}(yᵢ, yⱼ) represents the shape of the Gaussian distribution. The Gaussian kernel function is positive definite and characteristic. By using a Gaussian kernel function as the kernel function, as mentioned above, the information of the probability distribution is preserved by kernel mean embedding.

The integrand function g_{PI} in a PI can be approximated as g\hat{ }_{PI} in expression (14) using the integral of a Gaussian kernel function.

$$[ Expression 14 ]$$

$$\begin{matrix}{\hat{g}}_{PI} ( y ) := {\int }_{{y}^{+}}^{+ ∞} {k}_{{Y}^{*}} ( r , y ) dr \\ = \frac{1}{2} ( 1 + erf ( \frac{y - {y}^{+}}{\sqrt{h}} ) )\end{matrix} \qquad ( 14 )$$

h is a constant such that h>0. h is also referred to as a bandwidth.

The error function erf is expressed as in expression (15).

$$[ Expression 15 ]$$

$$erf ( z ) := \frac{2}{\sqrt{π}} {\int }_{0}^{{z}_{{e}^{- {r}^{2}}}} dr \qquad ( 15 )$$

e represents Napier's constant.

The closer the value of the bandwidth h is to 0, the closer the approximation function g\hat{ }_{PI} is to the integrand function g_{PI}.

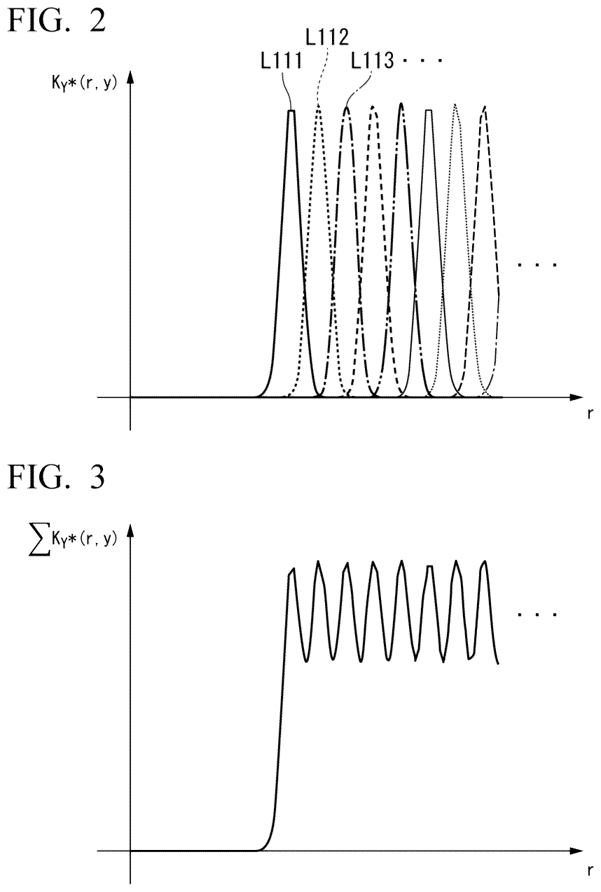

The integration of a Gaussian kernel function is further explained with reference to FIG. 2 to FIG. 5.

FIG. 2 is a diagram showing a plurality of examples of Gaussian kernel functions.

FIG. 2 shows an example in which a plurality of Gaussian kernel functions k_{Y*}(r, y) represented by expression (14) have been drawn with different values of r. The horizontal axis of the graph in FIG. 2 represents the value of the argument r. The vertical axis represents the value of the Gaussian kernel function k_{Y*}(r, y). Each of the lines L11, L112, L113, and so on, represent a Gaussian kernel function k_{Y*}(r, y).

FIG. 3 is a diagram showing an example of superimposition of a plurality of Gaussian kernel functions.

FIG. 3 shows an example in which the plurality of Gaussian kernel functions shown in FIG. 2 have been superimposed. That is to say, FIG. 3 shows an example in which the values of the plurality of Gaussian kernel functions shown in FIG. 2 have been added together. The horizontal axis of the graph in FIG. 3 represents the value of the argument r. The vertical axis represents the total value of the Gaussian kernel function k_{Y*}(r, y).

In the graph of FIG. 3, as the value of the argument r increases, the total value of the Gaussian kernel function k_{Y*}(r, y) becomes greater than 0, and then the total value of the Gaussian kernel function k_{Y*}(r, y) repeatedly increases and decreases. As the interval at which the plurality of Gaussian kernel functions are arranged becomes smaller, the magnitude of the increases and decreases becomes smaller, and approaches a constant value.

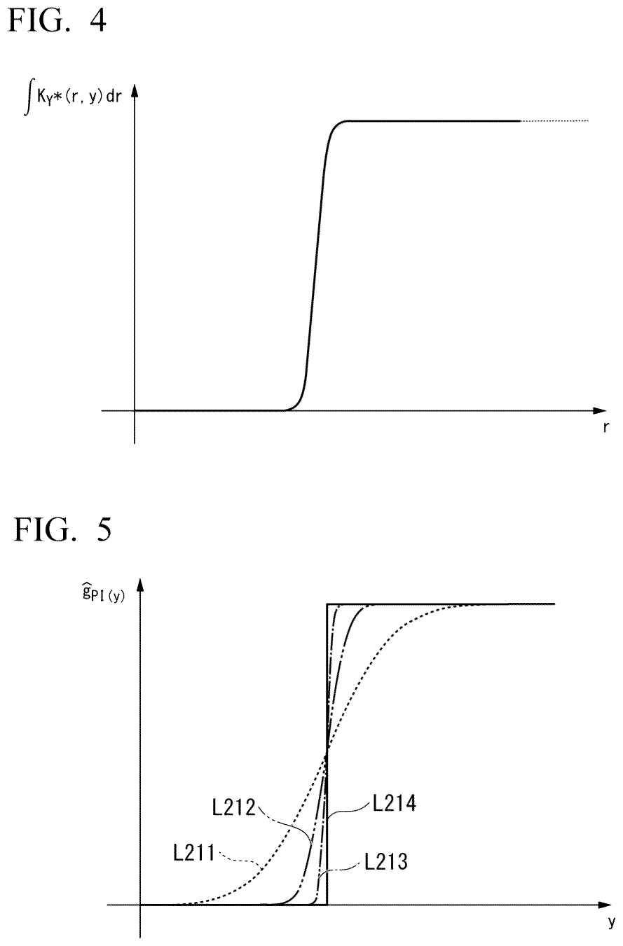

FIG. 4 is a diagram showing an example of integration of a Gaussian kernel function.

The horizontal axis of the graph in FIG. 4 represents the value of the argument r. The vertical axis represents the integral value of the Gaussian kernel function k_{Y*}(r, y).

In the graph of FIG. 4, as the value of the argument r increases, the integral value of the Gaussian kernel function k_{Y}(r, y) becomes greater than 0, and then the integral value of the Gaussian kernel function k_{Y*}(r, y) becomes a constant value.

The slope at which the integral value of the Gaussian kernel function k_{Y*}(r, y) rises depends on the magnitude of the bandwidth h in expression (14).

FIG. 5 is a diagram showing an example of the relationship between an approximation function g\hat{ }_{PI}(y) and a bandwidth h. As shown in formula (14) above, the integral of the integral of the Gaussian kernel function k_{Y*}(r, y) is used as the approximation function g\hat{ }_{PI}(y).

The horizontal axis of the graph in FIG. 5 represents the value of the argument y. The vertical axis indicates the value of the approximation function g\hat{ }_{PI}(y).

Each of the lines L211, L212, L213, and L214 indicates the value of the approximation function g\hat{ }_{PI}(y) for each value of the argument y. The line L211 has the largest value of the bandwidth h, and the value of the bandwidth h becomes smaller in order of the lines L212, L213, and L214. In the line L214, the value of the bandwidth h is close to 0, and the shape is the same as that of the graph of the integrand function g_{PI}. That is to say, the shape is the same as that of the graph of the unit step function.

As shown in the example of FIG. 5, as the value of the bandwidth h becomes smaller (becomes closer to 0), the slope of initial rise of the approximation function g\hat{ }_{PI}(y) becomes steeper, and the shape of the graph can be brought closer to that of the integrand function g_{PI}.

The PI acquisition function α_{PI} can be approximated as α\hat{ }_{PI} in expression (16).

$$[ Expression 16 ]$$

$$\begin{matrix}{\hat{α}}_{PI} ( x ) := {\hat{E}}_{Y \vert x} [ {\hat{g}}_{PI} ( y ) ] = {〈 {\hat{g}}_{PI} , {\hat{μ}}_{Y \vert x} 〉}_{H} \\ = \frac{1}{2} {\sum }_{i} {w}_{i} ( x ) ( 1 + erf ( \frac{{y}_{i} - {γ}^{+}}{\sqrt{h}} ) )\end{matrix} \qquad ( 16 )$$

As the value of the value of the bandwidth h becomes smaller (becomes closer to 0), the approximation function α\hat{ }_{PI} can be brought closer to the PI acquisition function α_{PI}.

As a result of the acquisition function acquiring unit 192 acquiring (calculating) the approximation function α\hat{ }_{PI} as the acquisition function, the sampling point determining unit 193 is capable of selecting, as the next sampling point, the sampling point having the highest probability of updating the maximum value of the sampling target data.

### (EI Acquisition Function)

An EI acquisition function α_{EI} is defined as an expected value that a random variable Y takes a value equal to or greater than a certain value y⁺, and is expressed as shown in expression (17).

$$[ Expression 17 ]$$

$$\begin{matrix}{α}_{EI} ( x ) := {\int }_{{y}^{+}}^{+ ∞} ( y - {y}^{+} ) dP ( y \vert x ) \\ = {E}_{Y \vert x} [ ( y - {y}^{+} ) u ( Y ) ]\end{matrix} \qquad ( 17 )$$

If the largest value of yᵢ of a given data set {(xᵢ, yᵢ)}ᵢ₌₁ⁿ is used as y⁺, according to an EI, it is possible to select, as the next sampling point, the value of x having the highest expected value of updating the maximum value of the value y of the random variable Y.

As shown in expression (17), the EI acquisition function α_{EI} is expressed as the expected value of the product of the difference obtained by subtracting a certain value y⁺ from the value y of the random variable in the conditional distribution P(Y|x), and the unit step function u(Y).

In the case of an EI, the product of the difference obtained by subtracting a certain value y⁺ from the value y of the random variable and the unit step function u is also referred to as the integrand function g_{EI} of the EI. The integrand function g_{EI} is expressed as in expression (18).

$$[ Expression 18 ]$$

$${g}_{EI} ( y ) = ( y - {y}^{+} ) u ( y ) \qquad ( 18 )$$

Here, an example will be described in which a Gaussian kernel function is used to express the integrand function g_{EI}=(y−y⁺)u(y) of the EI.

However, as described above, the kernel function used in the acquisition function that is acquired by the acquisition function acquiring unit 192 is not limited to the Gaussian kernel function, and various kernel functions capable of expressing or approximating the integrand function can be used. For example, in a case where the acquisition function acquiring unit 192 acquires the EI acquisition function (EI as the acquisition function, various kernel functions capable of expressing or approximating (y−y⁺)u(y) can be used as part of the EI acquisition function α_{EI}.

The integrand function g_{EI} in an EI can be approximated as g\hat{ }_{EI} in expression (19) using the integral of a Gaussian kernel function.

$$[ Expression 19 ]$$

$$\begin{matrix}{\hat{g}}_{EI} ( y ) := {\int }_{{y}^{+}}^{+ ∞} ( r - {y}^{+} ) {k}_{{Y}^{*}} ( r , y ) dr \\ = \frac{1}{2} ( ( y - {y}^{+} ) ( 1 + erf ( \frac{y - {y}^{+}}{\sqrt{h}} ) ) + \sqrt{\frac{h}{π}} exp ( - \frac{{( y - {y}^{+} )}^{2}}{h} ) )\end{matrix} \qquad ( 19 )$$

Also, in expression (19), the closer the value of the bandwidth h is to 0, the closer the approximation function g\hat{ }_{EI} is to the integrand function g_{EI}.

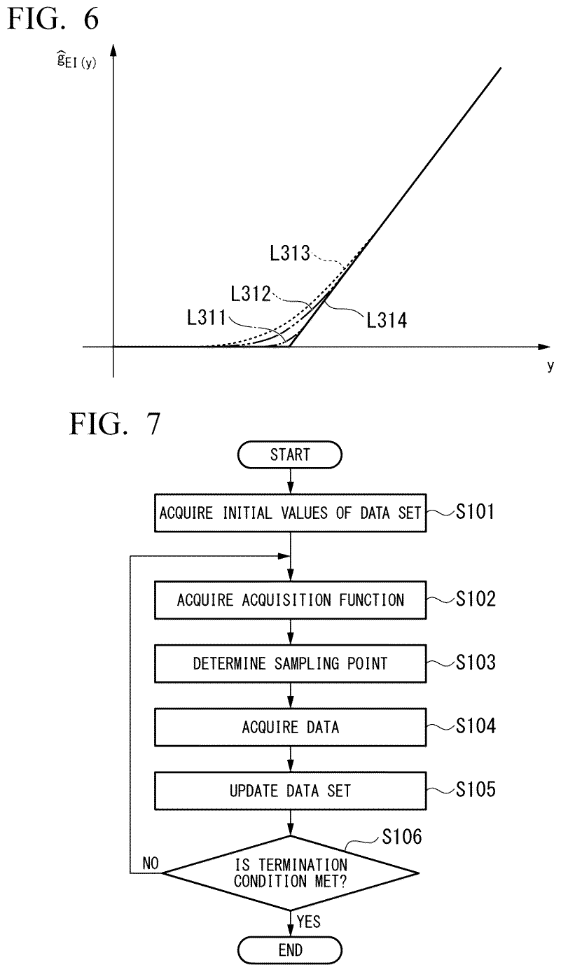

FIG. 6 is a diagram showing an example of the relationship between an approximation function g\hat{ }_{EI}(y) and a bandwidth.

The horizontal axis of the graph in FIG. 6 represents the value of the argument y. The vertical axis indicates the value of the approximation function g\hat{ }_{EI}(y).

Each of the lines L311, L312, L313, and L314 indicates the value of the approximation function g\hat{ }_{EI}(y) for each value of the argument y. The line L311 has the largest value of the bandwidth h, and the value of the bandwidth h becomes smaller in order of the lines L312, L313, and L314. In the line L314, the value of the bandwidth h is close to 0, and is the same graph as the graph of the integrand function g_{EI}. The graph of the integrand function g_{EI} is a graph obtained by translating the graph of a ramp function (rectified linear function (ReLU)) in the horizontal direction (the y axis direction in expression (18)).

As shown in the example of FIG. 6, as the value of the bandwidth h becomes smaller (becomes closer to 0), the initial rise of the approximation function g\hat{ }_{EI}(y) from the value 0 becomes steeper, and can be brought closer to the graph obtained by translating the graph of the integrand function g_{EI}, that is to say, the graph of the ramp function.

The EI acquisition function α_{EI} can be approximated as α\hat{ }_{EI} in expression (20).

$$[ Expression 20 ]$$

$$\begin{matrix}{\hat{α}}_{EI} ( x ) := {\hat{E}}_{Y \vert x} [ {\hat{g}}_{EI} ( y ) ] = {〈 {\hat{g}}_{EI} , {\hat{μ}}_{Y \vert x} 〉}_{H} \\ = \frac{1}{2} {\sum }_{i} {w}_{i} ( x ) ( ( y - {y}^{+} ) ( 1 + erf ( \frac{{y}_{i} - {y}^{+}}{\sqrt{h}} ) ) + \sqrt{\frac{h}{π}} exp ( - \frac{{( y - {y}^{+} )}^{2}}{h} ) )\end{matrix} \qquad ( 20 )$$

As the value of the value of the bandwidth h becomes smaller (becomes closer to 0), the approximation function α\hat{ }_{EI} can be brought closer to the EI acquisition function α_{EI}.

As a result of the acquisition function acquiring unit 192 acquiring (calculating) the approximation function α\hat{ }_{EI} as the acquisition function, the sampling point determining unit 193 is capable of selecting, as the next sampling point, the sampling point having the largest expected value of the update range of the maximum value of the sampling target data.

However, the acquisition function that is acquired by the acquisition function acquiring unit 192 is not limited to a PI acquisition function or an EI acquisition function. Various acquisition functions obtained using kernel mean embedding μ\hat{ }_{Y|x} of a conditional distribution estimated from a data set can be used as the acquisition function that is acquired by the acquisition function acquiring unit 192. Acquiring an acquisition function using kernel mean embedding μ\hat{ }_{Y|x} of a conditional distribution estimated from a data set can be considered as acquiring an acquisition function based on the probability distribution of sampling target data, with μ\hat{ }_{Y|x} as a surrogate model representing the probability distribution of the sampling target data.

The weights wᵢ(x) in expression (4) may be normalized. The normalization of the weights wᵢ(x) is shown in expression (21).

$$[ Expression 21 ]$$

$${w}_{i} ( x ) = \frac{{w}_{i} ( x )}{{\sum }_{i = 1}^{n} {w}_{i} ( x )} \qquad ( 21 )$$

In a case where the weights wᵢ(x) are normalized, the probability that the sampling point selected as the next point to be searched will be localized can be reduced. Here, in a case where the weights wᵢ(x) are not normalized, and if the candidates of the next sampling point are significantly separated from the sampling point at which data has already been sampled, the value of the weights wᵢ(x) for the candidates will be extremely small, and it may become difficult for a candidate sampling point that is significantly separated from the sampling point at which data has already been sampled to be selected. In contrast, in a case where the weights wᵢ(x) are normalized, it is expected that it will be relatively easier for the sampling point determining unit 193 to select a candidate sampling point that is significantly separated from the sampling point at which data has already been sampled. On the other hand, the weights wᵢ(x) do not have to be normalized. In this case, the amount of calculation required is relatively small since normalization of the weights wᵢ(x) is not required.

FIG. 7 is a diagram showing an example of a processing procedure by which the information processing device 100 performs a solution search. In the processing shown in FIG. 7, the data acquiring unit 191 acquires an initial value of a data set (step S101). Then, the acquisition function acquiring unit 192 acquires an acquisition function (step S102). As described above, the acquisition function acquiring unit 192 estimates the kernel mean embedding based on the data set, and acquires an acquisition function based on the estimated kernel mean embedding.

Then, the sampling point determining unit 193 determines a sampling point (step S103). The sampling point determining unit 193 selects the sampling point at which the value of the acquisition function becomes as large as possible, such as the sampling point at which the acquisition function takes a maximum value. Alternatively, depending on the acquisition function, the sampling point determining unit 193 may select the sampling point at which the value of the acquisition function becomes as small as possible, such as the sampling point at which the acquisition function takes a minimum value.

Next, the data acquiring unit 191 acquires sample target data of the sampling point that has been determined by the sampling point determining unit 193 (step S104). Then, the data acquiring unit 191 updates the data set by adding, to the data set, sample data in which the sampling point determined by the sampling point determining unit 193 and the sampling target data obtained at the sampling point are associated with each other (step S105).

Next, the processing unit 190 determines whether or not a termination condition of the solution search by the information processing device 100 is met (step S106).

The termination condition of the solution search by the information processing device 100 is not limited to a specific condition.

For example, the termination condition of the solution search by the information processing device 100 may be a condition indicating that sample data satisfying a predetermined threshold has been obtained. Further, for example, in a case where it is desirable to make the sampling target data as large as possible, the termination condition of the solution search by the information processing device 100 may be a condition indicating that sampling target data greater than or equal to a predetermined threshold has been obtained. Alternatively, in a case where it is desirable to make the sampling target data as small as possible, the termination condition of the solution search by the information processing device 100 may be a condition indicating that sampling target data less than or equal to a predetermined threshold has been obtained.

Alternatively, the termination condition of the solution search by the information processing device 100 may be a condition indicating that the magnitude of the fluctuation in the sampling target data between samplings has been reduced to equal to or greater than a predetermined condition. Further, for example, a termination condition of the solution search by the information processing device 100 may be a condition represented by expression (22) below.

$$[ Expression 22 ]$$

$$‖ {y}_{t} - {y}_{t - 1} ‖ < ε \qquad ( 22 )$$

yₜ represents the sampling target data obtained from the tth sampling.

∥ ∥ indicates the norm. Here, the norm is not limited to a specific norm. For example, the norm here may be an L1 norm, but it is not limited to this.

ε represents a predetermined threshold, and is a constant such that ε>0.

Expression (22) represents a condition in which the magnitude (norm) obtained by subtracting the sampling target data yₜ₋₁ obtained in the (t−1)th sampling from the sampling target data yₜ obtained in the tth sampling is smaller than a threshold 8.

Alternatively, for example, a termination condition of the solution search by the information processing device 100 may be a condition represented by expression (23) below.

$$[ Expression 23 ]$$

$$\frac{‖ {y}_{t} - {y}_{t - 1} ‖}{‖ {y}_{t} ‖} < ε \qquad ( 23 )$$

Expression (23) represents a condition in which the quotient obtained by dividing the magnitude (norm) obtained by subtracting the sampling target data yₜ₋₁ obtained in the (t−1)th sampling from the sampling target data yₜ obtained in the tth sampling, by the magnitude (norm) of the sampling target data yₜ obtained in the tth sampling is smaller than a threshold F.

In a case where the processing unit 190 determines in step S106 that the termination condition of the solution search by the information processing device 100 is not met (step S106:NO), the processing returns to step S102.

On the other hand, in a case where the processing unit 190 determines in step S106 that the termination condition of the solution search by the information processing device 100 is met (step S106:YES), the information processing device 100 ends the processing of FIG. 7.

As described above, the acquisition function acquiring unit 192 obtains an acquisition function using kernel mean embedding of a conditional distribution estimated from a data set obtained by data sampling. The sampling point determining unit 193 determines the sampling point at which data is acquired based on the acquisition function that has been acquired by the acquisition function acquiring unit 192. The data acquiring unit 191 acquires the data at the sampling point that has been determined by the sampling point determining unit 193.

According to the information processing device 100, in the respect that an acquisition function is acquired using kernel mean embedding of a conditional distribution estimated from a data set, in a case of determining the sampling point from which data is acquired, the probability distribution assumed for the value of the data to be acquired is not limited to a specific type of distribution.

Here, in Bayesian estimation using Gaussian process regression, which is known as a method of searching for a sampling point at which data is maximized or data is minimized, a Gaussian distribution is assumed as the conditional probability distribution of the data (probability distribution of data at each sampling point). For this reason, in Bayesian estimation using Gaussian process regression, in a case where the probability distribution of the data follows a distribution other than the Gaussian distribution, the estimation accuracy of the probability distribution becomes low, and in this respect, it is thought that the accuracy of the search for a sampling point will decrease.

For example, assuming a Gaussian distribution as a probability distribution is equivalent to expressing the probability distribution in terms of second order moments of a mean and a variance, it is plausible that a distribution having third or higher moments cannot be expressed in detail. Furthermore, for example, in a case where a Gaussian distribution is assumed as the probability distribution, it is plausible that a distribution that is asymmetric with respect to the mean cannot be expressed with high accuracy.

In contrast, in kernel mean embedding, the assumed probability distribution is not limited to a specific type of distribution, and various distributions can be assumed depending on the target of the data sampling. For example, in expression (3) above, various distributions can be assumed as the distribution of the conditional probability P(x|y) depending on the target of the data sampling. For example, a distribution with moments of any order can be assumed.

According to the information processing device 100, in this respect, it is possible to express the conditional distribution of the sampling target data with a relatively high accuracy, and it is expected that the search for a sampling point can be performed with a relatively high accuracy.

Furthermore, the acquisition function acquiring unit 192 acquires an acquisition function represented by an inner product of an expression represented by a linear combination of kernel functions, and an expression representing a kernel mean embedding of a conditional distribution estimated from the data set.

According to the information processing device 100, the calculation of the acquisition function can be performed by a relatively simple calculation such as calculation of an inner product. Therefore, the load of calculating the acquisition function is relatively small.

For example, in the information processing device 100, as in the examples of expressions (8) and (9), the integral calculation in the calculation of the acquisition function can be replaced with the calculation of an inner product.

In addition, the acquisition function acquiring unit 192 acquires an acquisition function represented by an inner product of an approximation of a unit step function expressed by an integral of one variable of a kernel function, which is a two-variable function, and an expression representing a kernel mean embedding of a conditional distribution estimated from the data set.

According to the information processing device 100, it is possible to acquire a PI acquisition function, and to select, as the next sampling point, a sampling point that has the highest probability of updating the maximum value or minimum value of the sampling target data. According to the information processing device 100, in this respect, it is expected that a solution search can be efficiently performed.

Also, the acquisition function acquiring unit 192 acquires an acquisition function represented by an inner product of an expression that is expressed by an integral for a variable taken with respect to a product of a difference between the variable and a predetermined value, and a kernel function, which takes the variable as an input, and an expression representing a kernel mean embedding of a conditional distribution estimated from the data set. According to the information processing device 100, it is possible to acquire an EI acquisition function, and to select, as the next sampling point, a sampling point that has the largest expected value of the update range of the maximum value or minimum value of the sampling target data. According to the information processing device 100, in this respect, it is expected that a solution search can be efficiently performed.

Furthermore, the acquisition function acquiring unit 192 normalizes a weighting coefficient for each sampling point using a kernel function for the sampling points, and calculates a kernel mean embedding of a conditional distribution estimated from the data set by taking a sum of products of the normalized weighting coefficient and a kernel function for sampling target data for the sampling points contained in the data set.

According to the information processing device 100, by normalizing the weighting coefficients, it is expected that even in a case where the candidates of the next sampling point are significantly separated from the sampling point at which data has already been sampled, it will be possible to prevent the weights wᵢ(x) for the candidates from becoming extremely small. As a result, in the information processing device 100, it is possible to reduce the probability that the sampling points selected by the sampling point determining unit 193 will be localized.

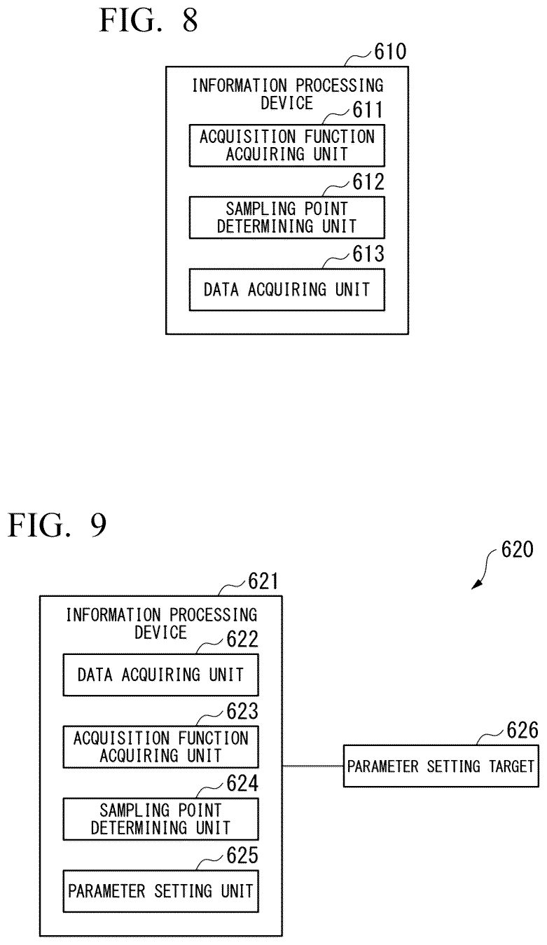

FIG. 8 is a diagram showing another example of a configuration of an information processing device according to several example embodiments of the present disclosure. In the configuration shown in FIG. 8, the information processing device 610 includes an acquisition function acquiring unit 611, a sampling point determining unit 612, and a data acquiring unit 613.

In such a configuration, the acquisition function acquiring unit 611 obtains an acquisition function using kernel mean embedding of a conditional distribution estimated from a data set obtained by data sampling. The sampling point determining unit 612 determines the sampling point at which data is acquired based on the acquisition function that has been acquired by the acquisition function acquiring unit 611. The data acquiring unit 613 acquires the data at the sampling point that has been determined by the sampling point determining unit 612.

The acquisition function acquiring unit 611 corresponds to an example of an acquisition function acquiring means. The sampling point determining unit 612 corresponds to an example of a sampling point determining means. The data acquiring unit 613 corresponds to an example of a data acquiring means.

According to the information processing device 610, in the respect that an acquisition function is acquired using kernel mean embedding of a conditional distribution estimated from a data set, in a case of determining the sampling point from which data is acquired, the probability distribution assumed for the value of the data to be acquired is not limited to a specific type of distribution.

Here, as mentioned above, in Bayesian estimation using Gaussian process regression, which is known as a method of searching for a sampling point at which data is maximized or data is minimized, a Gaussian distribution is assumed as the conditional probability distribution of the data (probability distribution of data at each sampling point). For this reason, in Bayesian estimation using Gaussian process regression, in a case where the probability distribution of the data follows a distribution other than the Gaussian distribution, the estimation accuracy of the probability distribution becomes low, and in this respect, it is thought that the accuracy of the search for a sampling point will decrease.

For example, assuming a Gaussian distribution as a probability distribution is equivalent to expressing the probability distribution in terms of second order moments of a mean and a variance, it is plausible that a distribution having third or higher moments cannot be expressed in detail. Furthermore, for example, in a case where a Gaussian distribution is assumed as the probability distribution, it is plausible that a distribution that is asymmetric with respect to the mean cannot be expressed with high accuracy.

In contrast, in kernel mean embedding, the assumed probability distribution is not limited to a specific type of distribution, and various distributions can be assumed depending on the target of the data sampling. For example, a distribution with moments of any order can be assumed.

According to the information processing device 610, in this respect, it is possible to express the conditional distribution of the sampling target data with a relatively high accuracy, and it is expected that the search for a sampling point can be performed with a relatively high accuracy.

The acquisition function acquiring unit 611 can, for example, be implemented using the functions of the acquisition function acquiring unit 192 of FIG. 1. The sampling point determining unit 612 can, for example, be implemented using the functions of the sampling point determining unit 193 of FIG. 1. The data acquiring unit 613 can, for example, be implemented using the functions of the data acquiring unit 191 of FIG. 1.

FIG. 9 is a diagram showing an example of a configuration of a system according to several example embodiments of the present disclosure. In the configuration shown in FIG. 9, the system 620 includes an information processing device 621 and a parameter setting target 626. The information processing device 621 includes a data acquiring unit 622, an acquisition function acquiring unit 623, a sampling point determining unit 624, and a parameter setting unit 625.

The parameter setting target 626 is a system or a device that operates in response to the setting of a parameter value. The parameter setting target 626 is not limited to a particular type of system or device, but can be a variety of systems or devices. For example, the parameter setting target 626 can be a system or a device that produces a certain product. Alternatively, the parameter setting target 626 may be a communication system or a communication device.

The information processing device 621 performs the same processing as the information processing device 100 of FIG. 1, and determines a parameter value to be set to the parameter setting target 626, and sets the determined parameter value to the parameter setting target 626. In the information processing device 621, the parameter value setting method is limited to a method that automatically sets the parameter value to the parameter setting target 626 without going through the user. The information processing device 621 uses an objective function representing an evaluation of the processing performed by the parameter setting target 626, and searches for a parameter such that the evaluation indicated by the objective function becomes as high as possible. The information processing device 621 is the same as the information processing device 100 in all other respects.

The data acquiring unit 622 is the same as the data acquiring unit 191 of FIG. 1, and acquires initial values of a data set, and then acquires sampling target data at the sampling point that has been determined by the sampling point determining unit 624, and updates the data set.

The acquisition function acquiring unit 623 is the same as the acquisition function acquiring unit 192 of FIG. 1, and estimates the kernel mean embedding based on the data set, and calculates an acquisition function using the estimated kernel mean embedding.

The sampling point determining unit 624 is the same as the sampling point determining unit 193 of FIG. 1, and determines the sampling point at which the data acquiring unit 622 samples data based on the acquisition function that has been acquired by the acquisition function acquiring unit 192. The sampling point determining unit 624 determines the parameter value of the parameter setting target 626 as a sampling point.

The parameter setting unit 625 is the same as the communication unit 110 of FIG. 1, and sets a parameter value to the parameter setting target 626. Specifically, the parameter setting unit 625, like the communication unit 110 of FIG. 1, transmits a parameter value to the parameter setting target 626, and sets the transmitted parameter value to the parameter setting target 626.

Specifically, the parameter setting unit 625 sets, to the parameter setting target 626, a parameter value that has been determined as a result of the data acquiring unit 622, the acquisition function acquiring unit 623, and the sampling point determining unit 624 repeating data sampling and updating the data set, acquiring an acquisition function using kernel mean embedding estimated based on the obtained data set, and determining the sampling point using the obtained acquisition function, until a termination condition of the parameter value search is met.

According to the system 620, the search for the parameter value that is set to the parameter setting target 626 is automatically performed without requiring a user operation, and the parameter value obtained as a result of the search can be set to the parameter setting target 626.

FIG. 10 is a diagram showing an example of a processing procedure of an information processing method according to several example embodiments of the present disclosure. The information processing method shown in FIG. 10 includes acquiring an acquisition function (step S611); determining a sampling point (step S612); and acquiring data (step S613).

In acquiring an acquisition function (step S611), a computer obtains an acquisition function using kernel mean embedding of a conditional distribution estimated from a data set obtained by data sampling.

In determining a sampling point (step S612), a computer determines a sampling point, from which data is acquired, based on the obtained acquisition function.

In acquiring data (step S613), a computer acquires data at the determined sampling point.

According to the information processing method shown in FIG. 10, in the respect that an acquisition function is acquired using kernel mean embedding of a conditional distribution estimated from a data set, in a case of determining the sampling point from which data is acquired, the probability distribution assumed for the value of the data to be acquired is not limited to a specific type of distribution.

Here, as mentioned above, in Bayesian estimation using Gaussian process regression, which is known as a method of searching for a sampling point at which data is maximized or data is minimized, a Gaussian distribution is assumed as the conditional probability distribution of the data (probability distribution of data at each sampling point). For this reason, in Bayesian estimation using Gaussian process regression, in a case where the probability distribution of the data follows a distribution other than the Gaussian distribution, the estimation accuracy of the probability distribution becomes low, and in this respect, it is thought that the accuracy of the search for a sampling point will decrease.

For example, assuming a Gaussian distribution as a probability distribution is equivalent to expressing the probability distribution in terms of second order moments of a mean and a variance, it is plausible that a distribution having third or higher moments cannot be expressed in detail. Furthermore, for example, in a case where a Gaussian distribution is assumed as the probability distribution, it is plausible that a distribution that is asymmetric with respect to the mean cannot be expressed with high accuracy.

In contrast, in kernel mean embedding, the assumed probability distribution is not limited to a specific type of distribution, and various distributions can be assumed depending on the target of the data sampling. For example, a distribution with moments of any order can be assumed.

According to the information processing device 610, in this respect, it is possible to express the conditional distribution of the sampling target data with a relatively high accuracy, and it is expected that the search for a sampling point can be performed with a relatively high accuracy.

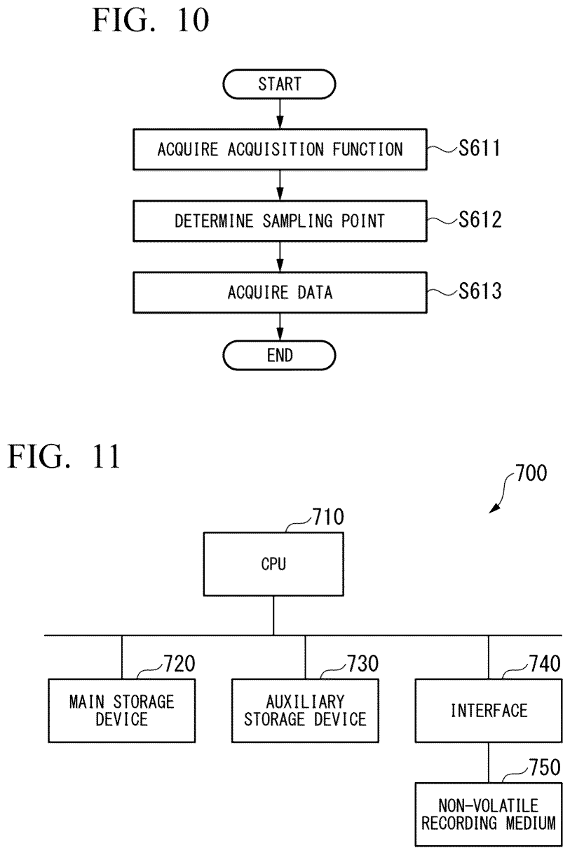

FIG. 11 is a schematic block diagram showing a configuration of a computer according to at least one example embodiment.

In the configuration shown in FIG. 11, a computer 700 includes a CPU 710, a main storage device 720, an auxiliary storage device 730, an interface 740, and a non-volatile recording medium 750.

At least one of the information processing device 100, the information processing device 610, and the information processing device 621, or a part thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 reserves a storage area corresponding to each of the storage units in the main storage device 720 according to the program. The communication of each device with other devices is executed as a result of the interface 740 having a communication function, and performing communication according to the control of the CPU 710. Furthermore, the interface 740 includes a port for the non-volatile recording medium 750, and reads information from the non-volatile recording medium 750 and writes information to the non-volatile recording medium 750.

In a case where the information processing device 100 is implemented by the computer 700, the operation of the processing unit 190 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the storage unit 180 in the main storage device 720 according to the program. The communication by the communication unit 110 with other devices is executed as a result of the interface 740 including a communication function and operating under the control of the CPU 710. The display of images by the display unit 120 is executed as a result of the interface 740 including a display device, and displaying various images under the control of the CPU 710. The reception of user operations by the operation input unit 130 is executed as a result of the interface 740 including an input device, and receiving user operations under the control of the CPU 710.

In a case where the information processing device 610 is implemented by the computer 700, the operation of each unit thereof is stored in the auxiliary storage device 730 in the form of a program. The CPU 710 reads the program from the auxiliary storage device 730, expands the program in the main storage device 720, and executes the processing described above according to the program.

In addition, the CPU 710 reserves a storage area in the main storage device 720 for the information processing device 610 to perform processing according to the program. The communication between the information processing device 610 and other devices is performed by the interface 740 having a communication function and operating under the control of the CPU 710. The interactions between the information processing device 610 and the user are performed by the interface 740 having a display device, and input/output devices such as a controller, a mouse, and a keyboard, and operating under the control of the CPU 710.

In a case where the information processing device 621 is implemented by the computer 700, the operation of each unit thereof is stored in the auxiliary storage device 730 in the form of a program. The CPU 710 reads the program from the auxiliary storage device 730, expands the program in the main storage device 720, and executes the processing described above according to the program.

Also, the CPU 710 reserves a storage area in the main storage device 720 for the information processing device 621 to perform processing according to the program. The communication between the information processing device 621 and other devices is executed as a result of the interface 740 including a communication function and operating under the control of the CPU 710. The interactions between the information processing device 621 and the user are executed as a result of the interface 740 having a display device, and input/output devices such as a display device, a controller, a mouse, and a keyboard, and operating under the control of the CPU 710.

One or more of the programs described above may be recorded in the non-volatile recording medium 750. In this case, the interface 740 may read out the program from the non-volatile recording medium 750. Then, the CPU 710 may directly execute the program that has been read out by the interface 740, or execute the program after temporarily saving the program in the main storage device 720 or the auxiliary storage device 730.

A program for executing some or all of the processing performed by the information processing device 100 and the information processing device 610 may be recorded in a computer-readable recording medium, and the processing of each unit may be performed by a computer system reading and executing the program recorded on the recording medium. The “computer system” referred to here is assumed to include an OS (operating system) and hardware such as a peripheral device.

In addition, the “computer-readable recording medium” refers to a portable medium such as a flexible disk, a magnetic optical disk, a ROM (read only memory), or a CD-ROM (compact disc read only memory), or a storage device such as a hard disk built into a computer system. Moreover, the program may be one capable of realizing some of the functions described above. Further, the functions described above may be realized in combination with a program already recorded in the computer system.

Example embodiments of the present invention have been described in detail above with reference to the drawings. However, specific configurations are in no way limited to the example embodiments, and include designs and the like within a scope not departing from the spirit of the present invention.

Apart or all of the example embodiment described above can be written as in the supplementary notes below, but is not limited thereto.

### (Supplementary Note 1)

An information processing device comprising:
an acquisition function acquiring means that acquires an acquisition function using kernel mean embedding of a conditional distribution estimated from a data set obtained by data sampling;
a sampling point determining means that determines a sampling point, from which data is acquired, based on the acquisition function; and
a data acquiring means that acquires data at the sampling point determined by the sampling point determining means.

### (Supplementary Note 2)

The information processing device according to supplementary note 1, wherein the acquisition function acquiring means acquires an acquisition function represented by an inner product of an expression expressed by a linear combination of kernel functions, and an expression representing a kernel mean embedding of a conditional distribution estimated from the data set.

### (Supplementary Note 3)

The information processing device according to supplementary note 2, wherein the acquisition function acquiring means acquires the acquisition function represented by an inner product of an approximate expression of a unit step function expressed by an integral of one variable of a kernel function and an expression representing a kernel mean embedding of a conditional distribution estimated from the data set, the kernel function being a two-variable function.

### (Supplementary Note 4)

The information processing device according to supplementary note 2, wherein the acquisition function acquiring means acquires the acquisition function represented by an inner product of: an expression expressed by an integral, with respect to a variable, of a product of a difference between the variable and a predetermined value, and a kernel function; and an expression representing a kernel mean embedding of a conditional distribution estimated from the data set, the kernel function being a two-variable function that takes the variable as an input.

### (Supplementary Note 5)

The information processing device according to any one of supplementary notes 1 to 4, wherein the acquisition function acquiring means normalizes a weighting coefficient calculated for each sampling point using a kernel function for the sampling points, and calculates a kernel mean embedding of a conditional distribution estimated from the data set by taking a sum of products of the normalized weighting coefficient and a kernel function for sampling target data of the sampling points included in the data set.

### (Supplementary Note 6)

An information processing method executed by a computer, comprising:
acquiring an acquisition function using kernel mean embedding of a conditional distribution estimated from a data set obtained by data sampling;
determining a sampling point, from which data is acquired, based on the acquisition function; and
acquiring data at the determined sampling point.

### (Supplementary Note 7)

A recording medium that stores a program that causes a computer to execute:
acquiring an acquisition function using kernel mean embedding of a conditional distribution estimated from a data set obtained by data sampling;
determining a sampling point, from which data is acquired, based on the acquisition function; and
acquiring data at the determined sampling point.

Priority is claimed on Japanese Patent Application No. 2022-164055, filed Oct. 12, 2022, the disclosure of which is incorporated herein in its entirety.

### INDUSTRIAL APPLICABILITY

The present invention may be applied to an information processing device, an information processing method, and a recording medium.

### REFERENCE SIGNS LIST

100, 610, 621 Information processing device
110 Communication unit
120 Display unit
130 Operation input unit
180 Storage unit
190 Processing unit
191, 613, 622 Data acquiring unit
192, 611, 623 Acquisition function acquiring unit
193, 612, 624 Sampling point determining unit
625 Parameter setting unit

1. An information processing device comprising:
a memory configured to store instructions; and
a processor configured to execute the instructions to:
acquire an acquisition function using kernel mean embedding of a conditional distribution estimated from a data set obtained by data sampling;
determine a sampling point, from which data is acquired, based on the acquisition function; and
acquire data at the determined sampling point.

2. The information processing device according to claim 1, wherein the processor is configured to execute the instructions to acquire an acquisition function represented by an inner product of an expression expressed by a linear combination of kernel functions, and an expression representing a kernel mean embedding of a conditional distribution estimated from the data set.

3. The information processing device according to claim 2, wherein the processor is configured to execute the instructions to acquire the acquisition function represented by an inner product of an approximate expression of a unit step function expressed by an integral of one variable of a kernel function and an expression representing a kernel mean embedding of a conditional distribution estimated from the data set, the kernel function being a two-variable function.

4. The information processing device according to claim 2, wherein the processor is configured to execute the instructions to acquire the acquisition function represented by an inner product of: an expression expressed by an integral, with respect to a variable, of a product of a difference between the variable and a predetermined value, and a kernel function; and an expression representing a kernel mean embedding of a conditional distribution estimated from the data set, the kernel function being a two-variable function that takes the variable as an input.

5. The information processing device according to claim 1, wherein the processor is configured to execute the instructions to normalize a weighting coefficient calculated for each sampling point using a kernel function for the sampling points, and calculate a kernel mean embedding of a conditional distribution estimated from the data set by taking a sum of products of the normalized weighting coefficient and a kernel function for sampling target data of the sampling points included in the data set.

6. An information processing method executed by a computer, comprising:
acquiring an acquisition function using kernel mean embedding of a conditional distribution estimated from a data set obtained by data sampling;
determining a sampling point, from which data is acquired, based on the acquisition function; and
acquiring data at the determined sampling point.

7. A non-transitory recording medium that stores a program that causes a computer to execute:
acquiring an acquisition function using kernel mean embedding of a conditional distribution estimated from a data set obtained by data sampling;
determining a sampling point, from which data is acquired, based on the acquisition function; and
acquiring data at the determined sampling point.
